(19) United States
(12) Patent Application Publication
(10) Pub. No.: US 2004/0022700 A1
(43) Pub. Date: Feb. 5, 2004

(54) Method and apparatus for removing pollutants using photoelectrocatalytic system

(76) Inventors: Hak Soo Kim, Chungcheongnam-do (KR); Yong Gun Shul, Seoul (KR); Ju Hyeon Lee, Chungcheongnam-do (KR); Soo Jae Yu, Chungcheongnam-do (KR)

Correspondence Address: GREENBLUM & BERNSTEIN, P.L.C., 1950 ROLAND CLARKE PLACE, RESTON, VA, 20191, US

(21) Appl. No.: 10/297,445

(22) PCT Filed: Jun. 9, 2001
(86) PCT No.: PCT/KR01/00991

(30) Foreign Application Priority Data
Jun. 10, 2000 (KR) 2000/31957

(51) Int. Cl. B01J 19/08

(52) U.S. Cl. 422/186.3; 422/186

(57) ABSTRACT

Disclosed is a photoelectrocatalytic purifier and a method for purifying fluid such as air by using the photoelectrocatalytic purifier. The photoelectrocatalytic purifier according to the present invention is characterized in that it comprises a discharge plate having anode property, a discharge section being positioned parallel to the discharge plate and having cathode property, a photocalyst being coated on a discharge surface of the discharge plate, ultraviolet lamps being disposed on a rear of the discharge section, and a power supply and booster for supplying a voltage.

### TECHNICAL FIELD

The present invention generally relates to a photoelectrocatalytic purifier and a purifying method thereof for removing various kinds of pollutants such as volatile organic compounds, particulate matter like tobacco smoke, unpleasant cooking odors, stink ingredients and so on, and more particularly, to a photoelectrocatalytic purifier and a purifying method thereof for removing pollutants, the purifier being provided with a high voltage discharge plate coated with a photocatalyst thin film.

### BACKGROUND ART

In general, a photocatalytic air purifier is comprised of an ultraviolet lamp and a photocatalyst. If an ultraviolet light, the energy of which is higher than the band gap energy, is applied to a photocatalyst, the electrons filled in the valence band of the photocatalyst are excited and move to a conduction band. This generates free electrons in the conduction band and positively charged holes in the valence band. At this time, if there exists a proper electron acceptor or electron donor in the vicinity of the electrons and the holes, an oxidation-reduction reaction is brought about.

The positively charged holes oxidize substances in the vicinity thereof. For example, various pollutants such as volatile organic compounds and tobacco smoke, as electron donors, give their electrons to holes remaining in the valence band, become oxidized and decompose. Thereby, the pollutants contained in a fluid like air are oxidized or removed. The free electrons perform a reduction reaction, which generally converts oxygen into a reactive oxygen species (Fujishima, A. and Honda, K, Nature, 1972, Vol.37, pp238).

Since the reaction on the photocatalyst is mainly carried out by the holes and the electrons, an attempt to prevent recombination between the electrons and the holes and prolong their useful life is made for the very purpose of enhancing activity of the photocatalyst. The lifetime of both the electrons and the holes on the photocatalyst depends on a velocity at which the electrons that have moved to the conduction band are transferred to an acceptor, adsorbed on the surface of the catalyst, and a velocity at which a donor's electrons are trapped in the holes in the valance band.

The photo-semiconductor system, namely the photocatalytic system, which has been widely used in purifying air in the prior art, however, has the drawback of the excited electrons recombining with the holes in the valence band as time passes, thereby deteriorating the activity of the photocatalyst. Once the electrons recombine with the holes, the photo-semiconductor loses its capacity to oxidize and decompose pollutants. In consequence, the photocatalyst system suffers a decreased performance in purifying the air. Many attempts have been made to develop a method for preventing the electron-hole recombination. U.S. Pat. No. 5,126,111 discloses a method for performing the photocatalyst reaction under ozone or under ozonized oxygen and hydrogen peroxide to inhibit the electron-hole recombination.

As a method for removing harmful substances, there is an electronic cleaning method using a high voltage discharger and collector system (or an electrostatic precipitator), aside from the photo-semiconductor system. The method is primarily used for removing the pollutants in the air. Although the method has excellent efficiency in reducing dust, tobacco smoke, and pollutants in the air of large particle size, it has the disadvantage of failing to decompose adsorption-hard volatile organic compounds. O₃ generated during the high voltage discharge oxidizes the pollutants in the air and functions as a sterilizer at low densities below 0.12 ppm, whereas it does harm to humans especially to infants, the elderly and the infirm at densities over 0.12 ppm. Thus, if the system is operated for a long time in a closed space, it may increase human health risks.

In these circumstances, the inventors, recognizing the problems that the photocatalyst system and the high voltage discharge collector system confront, have finally developed a photoelectrocatalytic system, which can decompose chemical substances, especially volatile organic compounds as well as particulate substances, by applying a coat of photocatalyst thin film on to the discharge surface of a discharging and collecting plate (hereinafter referred to as a “discharge plate”).

### DISCLOSURE OF INVENTION

It is, therefore, an object of the present invention to provide a novel photoelectrocatalytic purifier, which is provided with a discharge plate coated with a photocatalyst thin film on its discharge surface, and a purifying method by using the same photoelectrocatalytic purifier.

It is another object of the present invention to provide a photoelectrocatalytic purifier with a sensor for measuring air pollution levels installed thereon.

To achieve the above objects, there is provided a photoelectrocatalytic purifier equipped with a discharge plate coated with a photocatalyst thin film on its discharge surface. The present purifier is characterized in that it comprises a discharge plate having (+) anode property; a discharge section being positioned parallel to the discharge plate and having (−) cathode property; a photocatalyst being coated on the discharge surface of the discharge plate; UV(Ultraviolet) lamps being disposed on the rear of the discharge section; and a power supply and booster for supplying a voltage, namely a DC voltage and a high voltage, to the discharge plate and the discharge section. Optionally, the present purifier may be provided with an air circulating fan and/or a sensor to measure air pollution levels, and/or a dust-collecting filter, and/or an active carbon based filter.

The purifier according to the present invention is suitable for removing pollutants from fluid, in particular, from air. Such pollutants include particulate matter like tobacco smoke or dust, volatile organic compounds like aldehydes or benzene, aromatic chemical compounds and unpleasant cooking odors.

A conventional air purifier using an electrostatic precipitator which is comprised of a dust collecting electrode, and a discharging wire, fails to remove chemical compounds like volatile organic compounds, although it is capable of removing particulate matter. In addition, it has the disadvantage of generating a large quantity of ozone. In contrast to the air purifier using an electrostatic precipitator, a conventional air purifier using a photocatalyst has the disadvantage of failing to remove particulate matter. The photoelectrocatalytic purifier according to the present invention is capable of removing both particulate matter and volatile organic compounds as well as reducing the quantity of ozone generated.

The discharge plate according to the present invention prevents recombination between electrons and holes by trapping the electrons excited from the photocatalyst, thus maintaining the activity of the photocatalyst for a long time, collects and removes charged particulate matter, and reduces the quantity of ozone discharged outside of the purifier by using the ozone generated in the discharge system as a photooxidation agent. Therefore, the photocatalyst layer coated on the discharge plate removes volatile chemical compounds and at the same time carries out purification by the electrostatic precipitator.

### BRIEF DESCRIPTION OF THE DRAWINGS

Further objects and advantages of the invention can be more fully understood from the following detailed description taken in conjunction with the accompanying drawings, in which:

FIG. 1 is a view illustrating a construction of a photoelectrocatalytic purifier according to the present invention;

FIG. 2 is a schematic diagram showing the mechanism of the photocatalyst applied to the present invention;

FIG. 3 is a schematic view illustrating an electron current in a discharge plate having anode property according to the present invention; and

FIG. 4 is a graph showing decomposition of benzene over time by a photoelectrocatalytic purifier according to the present invention.

### BEST MODE FOR CARRYING OUT THE INVENTION

The present invention will now be described in connection with preferred embodiments with reference to the accompanying drawings.

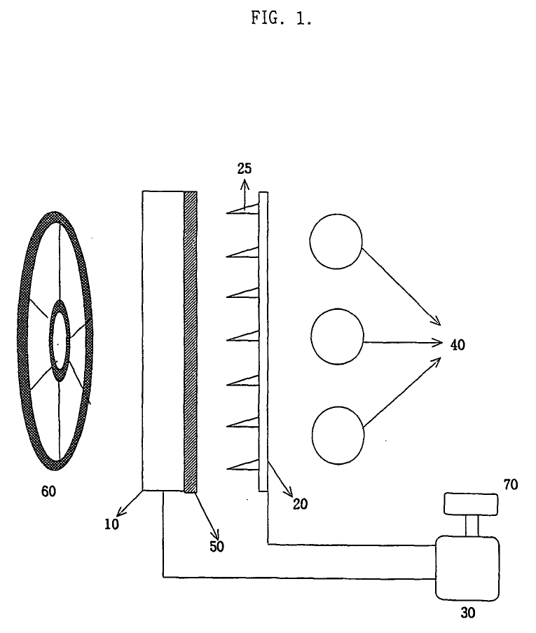

FIG. 1 is a view illustrating a preferred embodiment of the present invention. A photoelectrocatalytic purifier according to the present invention will be explained in detail with reference to FIG. 1.

The photoelectrocatalytic purifier according to the present invention is characterized in that it comprises a discharge plate (10) having (+)anode property; a discharge section (20) being positioned parallel to the discharge plate and having (−)cathode property; a photocatalyst (50) being coated on the discharge surface of the discharge plate (10); a plurality of UV(Ultraviolet) lamps (40) being disposed on the rear of the discharge section (20); a power supply and booster (30) for supplying a voltage, namely a DC voltage and a high voltage, to the discharge plate (10) and the discharge section (20); an air circulating fan (60) being disposed on a front side of the discharge plate (10); and a sensor (70) for measuring air pollution level. Contaminated fluid flows through a fluid inlet, and purified fluid is discharged through an outlet.

The discharge plate (10) traps electrons excited from the photocatalyst layer (50) and serves to constantly-maintain the oxidation site on the photocatalyst. The discharge plate (10) is formed of a metallic substance capable of transferring charges, namely, a conductive substance, such as aluminum or copper. FIG. 1 illustrates the photoelectrocatalytic purifier as being a flat type. It is out of the question, however, that the photoelectrocatalytic purifier can take any shape suitable for maximizing the surface area of the photocatalyst and ensuring a smooth flow of the fluid. If holes whose area corresponding to the minimum dimension of a prickle portion (25) of the discharge section are punched to enable the inside air to flow, the back pressure load is reduced, smooth air flow is achieved and the efficiency of the fan is enhanced, thereby reducing the energy consumption. It is desirable to have an open type discharge plate to make plenty of UV irradiation possible.

The discharge section (20) is made of a metallic substance of high conductivity, such as copper or the like. The discharge section preferably has an open shape, such that the light coming from an ultraviolet ray source is transferred to the discharge plate with minimal disturbance. Volatile ohmic compounds receive electrical energy while they pass through the discharge section and are partially converted into plasma When the charged volatile organic compounds make contact with the photocatalyst surface of the discharge plate, the energy of the charged volatile organic compounds excite the electrons of the photocatalyst, thereby increasing the activity of the photocatalyst.

The photocatalyst (50) is a substance capable of converting light energy into chemical energy. The metallic compound of the photocatalyst is a semiconductor. The photocatalyst substance (50) comprises a valence band E, a conduction band D and a band gap G. The band gap G is a characteristic value, different for each photocatalyst The photocatalyst is selected from the group consisting of a metallic oxide such as TiO₂, WO₃, SrTiO₃, a-Fe₂O₃, SnO₃, ZnO, etc., a metallic sulfide such as CdS, ZnS, MoS₂, etc., and an iron compound such as α-Fe₂O₃, α-FeOOH, β-FeOOH, δ-FeOOH, etc. The said photocatalyst may be used as a single component or as mixtures thereof.

The photocatalyst is preferably TiO₂. The band gap G of TiO₂ is approximately 3 eV corresponding to 400 nm in wavelength. Therefore, if light having a wavelength shorter than 400 nm is applied, the electrons in the valence band become excited.

The photocatalyst according to the present invention is coated on the discharge surface of the discharge plate. There are many documents setting out a method for coating a photocatalyst. There is an example entitled “Preparing Catalytic Materials by the Sol-Gel Method”, Ind, Eng. Chem, Res. 34, 421-433, by David a. ward and Edmon I. Ko., issued in 1995. A binder may be used for the photocatalyst to be well coated to the surface of the discharged plate. An example of a binder is a substance such as a silicide. A transition metal like SnO₂ or a noble metal like platinum may be added to the surface of the photocatalyst in an amount of 1-10 weight % based on the total weight.

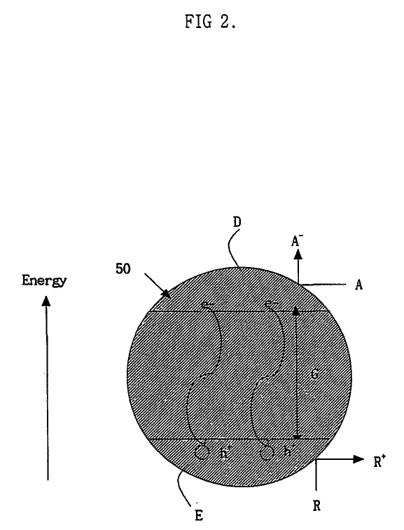

FIG. 2 is a schematic diagram showing the mechanism of the photocatalyst applied to the present invention. When light is applied to the photocatalyst, electrons e⁻ and holes h⁺ are generated inside of the photocatalyst. They react with the adsorbed materials. As a result, A (an electron acceptor) will be reduced into A⁻ and the alkali R (an electron donor) will be oxidized into R⁺.

The ultraviolet lamps (40) are installed on the rear of the discharge section (20) having cathode property. The capacity and number of ultraviolet lamps can be adjusted according to the size of the reactor. Laminating the ultraviolet lamps (40), the discharge section (20) and the discharge plate (10) can effect purification enhancement The power supply and booster (30) supplies power and has a circuit board therein for boosting the general voltage 22V for domestic use up to a voltage ranging between 3000V and 20000V.

The fan is preferably positioned behind the discharge plate, and plays the role of adjusting the flow of air to be purified. The sensor senses the density of air pollutants and sends an electrical signal to the control part.

A method for removing the pollutants by using the photoelectrocatalytic purifier according to the present invention will be explained. An anode of the power is connected to the discharge plate (10) and a cathode of the power is connected to the discharge section (20). A DC voltage supplied from the power supply and booster (30) is supplied to the ultraviolet lamps (40). The ultraviolet lamps (40) emit the light energy in an ultraviolet range of 400 nm or below. Ultraviolet rays below 400 nm emitted from the ultraviolet lamps (40) are applied to the photocatalyst (50) through the discharge section

If the electrons absorb light energy greater than the band gap G, after receiving UV rays below 400 nm applied to the photocatalyst (50), the electrons in the photocatalyst (50) filled in the valence band E move to the conduction band D as shown in FIG. 2, a process called: excitation. Here, the oxidizing power of the holes h⁺ is greater than the reducing power of the excited electrons e⁻. Hence, in most cases, once the electrons e⁻ are excited, the holes h⁺ remaining in the valence band E receive the electrons from airborne pollutants such as volatile organic compounds or tobacco smoke and the like, and oxidize and decompose the pollutants. Volatile organic compounds are oxidized into H₂O and CO₂ and removed as shown in the following chemical formula.

VOC (Volatile Organic Compound)→CO₂+H₂O

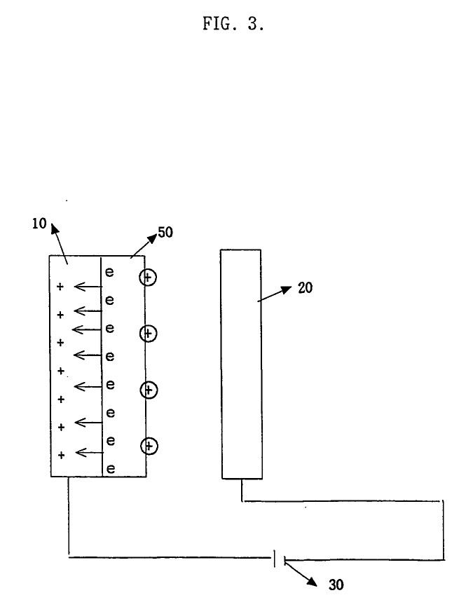

Of particular importance regarding photocatalyst purifiers is maintaining the electrons and the holes in active condition, in other words, preventing the recombination of the electrons and holes. The high voltage anode of the present purifier is connected to the discharge plate (10) and the cathode is connected to the discharge section (20). Thus, as illustrated in FIG. 3, the electrons generated at the discharge section (20) having cathode property move to the discharge plate (10) having anode property. The electrons e excited within the photocatalyst flow into the high voltage discharge plate 10. In consequence, the photoelectrocatalytic purifier according to the present invention prevents the recombination of the electrons e− and the holes h⁺ which can decrease the activity of photocatalysts, resulting in the enhancement of performance in air purification.

The high voltage discharge of the photoelectrocatalytic purifier according to the present invention has an electric collecting effect, wherein dust particles in the air are absorbed on the discharge plate (10) and O₃ is generated. O₃ acts as a strong oxidizer, in that it oxidizes the pollutants including volatile organic compounds, so as to purify the air.

The performance of the photoelectrocatalytic purifier according to the present invention is adjusted depending on the strength of the fan (60) and strength of the voltage. The strength of the fan and the voltage can be automatically controlled through the sensor (70) which measures the level of air pollution. This enables us to save power.

The working examples described below show the purification capability of the present purifier.

TiO₂ (anatase) powder (Aldrich Chemical Co.) of reagent grade was used as a photcatalyst. UV lamps were GLK8CQ(UV-C, Aankyodenki Co.). Benzene was put inside a closed 10L reactor at a density of 1 Vol %. The purification effect in terms of benzene decomposition was compared to the photoelectrocatalytic purifier according to the present invention, a purifier using only the ultraviolet lamps, and a high voltage discharge purifier. The benzene inside the reactor was analyzed by reaction time through gas chromatography (HP-6890). The GC Detector was a FID type, and the temperature was 200° C. at the inlet, 50-150° C. (temperature rise velocity: 5 degrees/min) at the oven and 250° C. at the detector. The gas chromatography column was HP-5. The carrier gas was He and the flow rate was 20 ml/min.

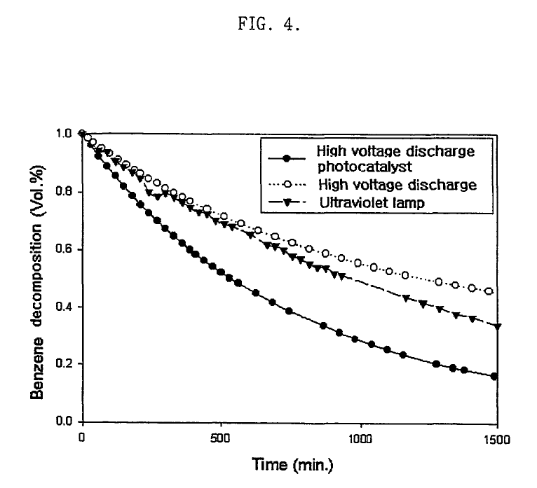

The results are shown in FIG. 4. The ultraviolet lamp purifier is slightly superior in decomposing benzene to the high voltage discharge purifier. However, the photoelectrocatalytic purifier according to the present invention shows about a 50% higher purification rate than the ultraviolet lamp purifier. The additional power consumed to increase the purification rate by 50% was 10% or less.

Industrial Applicability

As stated above, the present photoelectrocatalytic purifier using the high voltage discharge plate has the advantage of removing volatile organic compounds in the air and particulate substances like the tobacco smoke as well as the odor components of food such as the smell of kimchi. Furthermore, the present invention can be applied to the treatment of ozone generated in urban and metropolitan centers. Since hydrogen, an alternative energy for the next generation, can be obtained through the photocatalytic decomposition reaction, it also contributes to the development of clean energy.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A photoelectrocatalytic purifier characterized in that it comprises:
a discharge plate having (+)anode property;
a discharge section being positioned parallel to the discharge plate and having (−) cathode property;
a photocatalyst being coated on a discharge surface of the discharge plate;
ultraviolet lamps being disposed on the rear of the discharge section; and
a power supply and booster for supplying a voltage.

2. The purifier according to claim 1, firer comprising one or more selected from the group consisting of an air circulating fan, a sensor to measure the level of the air pollution, a dust collecting filter and an active carbon based filter.

3. The purifier according to claim 1 or 2, wherein the discharge plate is formed of metal selected from the group consisting of aluminum and copper

4. The purifier according to claim 1, wherein the photocatalyst is one or a mixture of the compounds selected from the group consisting of TiO₂, WO₃, SrTiO₃, a-Fe₂O₃, SnO₃, ZnO, CdS, ZnS, MoS₂, α-Fe₂O₃, α-FeOOH, β-FeOOH, and δ-FeOOH.

5. The purifier according to claim 1 or 2, wherein the photocatalyst is TiO₂.

6. The purifier according to claim 1 or 2, wherein a transition metal oxide or a noble metal is added to the photocatalyst.

7. A method for purifying fluid by using the purifier of claim 1 or 2.
